(19) United States
(12) Patent Application Publication
(10) Pub. No.: US 2007/0265734 A1
(43) Pub. Date: Nov. 15, 2007

(54) TRAFFIC INFORMATION SYSTEM

(76) Inventor: Christopher M. Clark, Knoxville, TN (US)

Correspondence Address: LUEDEKA, NEELY & GRAHAM, P.C., P O BOX 1871, KNOXVILLE, TN, 37901, US

(21) Appl. No.: 11/278,973

(22) Filed: Apr. 7, 2006

(51) Int. Cl. G05D 1/00; G05D 3/00; G06F 17/00; G06F 7/00

(52) U.S. Cl. 701/1

(57) ABSTRACT

A traffic information system has a consumer component and a plurality of modules forming a network and for connecting to consumer components. The consumer component is disposed at a vehicle and is for receiving outside information and transmitting vehicle information. The consumer components have a component communication device, an interface, an output, and a power supply. The modules have a module communication device, a processor, a memory, and a power supply. A plurality of network stations forming a system receives outside information from an authority and transmits the outside information to the network of modules. The consumer components transmit vehicle information to the network of modules. The network communicates the information upstream and downstream along the network of modules an upstream notification distance and a downstream notification distance, respectively, each determined by an origin module. Each module receiving such information then transmits it to other vehicles.

### FIELD

The present invention relates to the field of networking along transportation media for communicating with vehicles on the transportation media. More particularly it relates to a radio network of consumer components and modules for communicating with vehicles on transportation media.

### BACKGROUND AND SUMMARY

Previous systems for communicating with drivers of vehicles provided drivers with useful information regarding speed limits. The systems transmitted on specific frequencies corresponding to speed limits and were limited in the types of information transmitted. Also, previous systems communicated the location of an accident using GPS, which is costly and relatively complicated to implement. Furthermore, previous systems were capable of transmitting information from stations along roadways but were limited in their ability to transmit information downstream and upstream on a roadway over defined distances to allow emergency vehicles to pass easily and to alert motorists to changing road conditions or accidents ahead, wherein downstream refers to the direction in which traffic is generally moving and upstream refers to the direction from which traffic is generally approaching.

Thus, a traffic information system is needed that provides modules alongside transportation media that are capable of communicating with each other and determining notification distances, and that are capable of transmitting and receiving different types of information on one frequency. A consumer component on a vehicle is also needed for transmitting a signal indicating an accident or emergency to the roadside modules where the roadside modules can determine the location of the accident or emergency vehicle without necessarily using GPS.

In a preferred embodiment, the invention provides a traffic information system for communicating with a driver of a vehicle having a consumer component disposed in the vehicle and a plurality of modules forming a network. The consumer component is for receiving outside information and transmitting vehicle information and has a component communication device, an interface connected to the component communication device, an output connected to the component communication device, and a power supply connected to the component communication device. The component communication device is for receiving outside information and transmitting vehicle information. The interface is for receiving input from the driver. The output is for displaying a human readable version of the outside and vehicle information, and the power supply is for supplying power to the consumer component.

According to the preferred embodiment each of the plurality of modules has a module communication device, a processor connected to the module communication device, a memory connected to the processor, and a power supply connected to the module communication device. The module communication device is for transmitting outside information to the component communication device and receiving vehicle information from the component communication device. The processor is for processing the outside information and the vehicle information, and the power supply is for supplying power to the module.

In some preferred embodiments, the network of modules may be programmed in an undershoot network configuration or an overshoot network configuration wherein an undershoot network configuration provides notification to modules at a distance less than a determined notification distance and an overshoot network configuration provides notification to modules at a distance greater than a determined notification distance and may provide notification to one additional module past the notification distance. Also the network of modules may be programmed in a receive zero stop configuration or a receive one stop configuration wherein a receive zero stop configuration the transmission of information stops when a module in the network receives a counter equal to zero and wherein a receive one stop configuration the transmission of information stops when a module in the network receives a counter equal to one. The network communicates with the consumer component substantially on one frequency within the Industrial, Scientific and Medical Band (“ISM”), wherein the ISM Band includes 902-928 MHz, 2.4-2.4835 GHz and 5.725-5.850 GHz bands. Each module responds to one frequency within the ISM Band and can transmit to other modules within its range at each of their specific ISM Band frequencies.

The outside information may be an emergency vehicle approaching signal or an accident ahead signal. The vehicle information may be the vehicle velocity, an upstream incident signal, or a downstream incident signal.

### BRIEF DESCRIPTION OF THE DRAWINGS

The preferred embodiments of the invention will now be described in further detail with reference to the drawings wherein like reference characters designate like or similar elements throughout the several drawings as follows:

FIG. 1 is a diagrammatic representation of a module connected to a consumer component.

FIG. 2A is a diagrammatic representation of a module sending a request-to-connect signal.

FIG. 2B is a diagrammatic representation of a user inputting a request for information command.

FIG. 2C is a diagrammatic representation of a module transmitting information.

FIG. 3 is an illustration of a network of modules disposed along transportation media.

FIG. 4 is an illustration of a network of modules and a network station disposed on transportation media and a representation of notification distances.

FIG. 5A is a diagrammatic representation of an undershoot network configuration.

FIG. 5B is a diagrammatic representation of an overshoot network configuration.

FIG. 6A is a diagrammatic representation of a receive zero stop configuration.

FIG. 6B is a diagrammatic representation of a receive one stop configuration.

FIG. 7 is an illustration of a network of modules and a system of network stations.

FIG. 8 is a diagram of the module network connected to the Internet via the Internet server.

FIG. 9A is a diagram of one embodiment of an advertising network showing business advertisers connected to the system control server through an Internet server.

FIG. 9B is a diagram of one embodiment of an advertising network showing a secondary communication channel.

FIG. 9C is a diagram of one embodiment of an advertising network showing network command stations and modules in place of the transmission stations and receiving devices of FIGS. 9A and 9B.

FIG. 9D is a is a diagram of one embodiment of an advertising network showing the system control server as part of the server.

FIG. 10 is a diagram of a city roadway intersection with a transmission station mounted on a light fixture.

### DETAILED DESCRIPTION

The present invention provides a radio system for vehicles, which is also referred to as a traffic information system. The preferred embodiment of the traffic information system includes modules distributed along transportation media such as a highway or interstate, preferably at substantially periodic distances from one another. Such modules are connected, physically or wirelessly, such that they are capable of communicating with each other. The modules preferably contain memory capable of storing information related to transportation media conditions including, but not limited to, accident information, traffic information, and weather information. The modules transmit such information constantly, periodically or when requested. The preferred embodiment of the system also includes consumer components which receive the transmitted information if it is transmitted continuously or periodically. Otherwise, the consumer components may constantly or periodically transmit a request for information, which is answered by one of the modules when the consumer component enters the range of such a module.

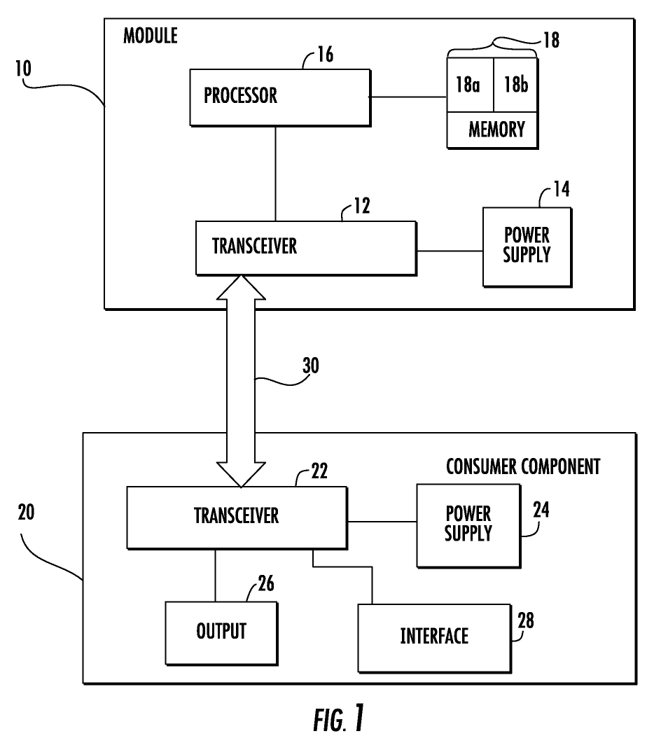

Referring now to FIG. 1, a preferred embodiment of a module 10 is shown in diagrammatic form in the upper portion of the figure. A preferred embodiment of a consumer component 20 is shown, also in diagrammatic form, in the lower portion of the figure. The module 10 is connected to the consumer component a wireless connection 30 which may be implemented via radio, infrared, or other wireless communication medium. In the preferred embodiment, the module 10 has a transceiver 12 powered by a power supply 14. The power supply 14 may be a battery, a rechargeable power supply such as a rechargeable battery, a solar power supply, or a hybrid system of any of the above or other power supplies. The transceiver 12 is connected to a processor 16, which is connected to a memory 18, such as random access memory (“RAM”) 18a, read only memory (“ROM”) 18b, or both.

The consumer component 20 also has a transceiver 22 powered by a power supply 24. The transceiver 22 is connected to an output 26 and an interface 28. The consumer component 20 may be included as part of a motor vehicle, cell phone, or personal digital assistant (“PDA”). Preferably, the consumer component 20 has transceivers 22, but may also have receivers without the capability of transmission. In the embodiment of FIG. 1, the consumer component 20 is within communication range of the module 10, such that the connection 30 is established between the module 10 and the consumer component 20.

In the preferred embodiment, the transceivers 12 and 22 include low power radio transmitters with transmission ranges of ten to one hundred feet operating in the Industry, Scientific and Medical Band (the “ISM Band”). The ISM Band includes 902-928 MHz, 2.4-2.4835 GHz and 5.725-5.850 GHz bands. Generally, transmitters operating in the ISM Band may have a radio frequency (“RF”) power of up to one Watt. The ISM Band was originally reserved for non-commercial use of RF electromagnetic fields for industrial, scientific and medical purposes. The transceivers 12 and 22 may transmit at predetermined, constant frequencies within the ISM Band.

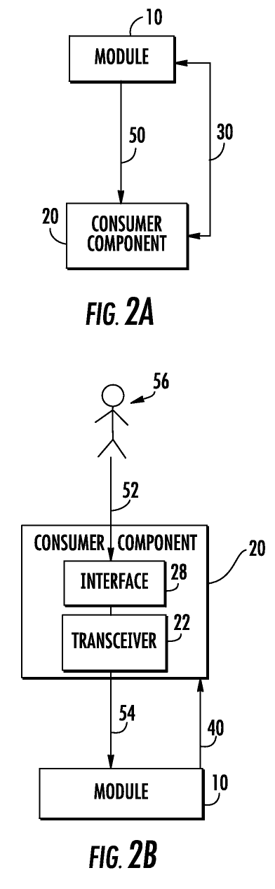

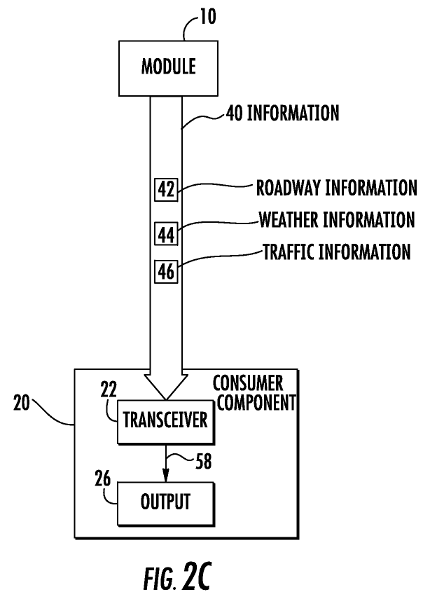

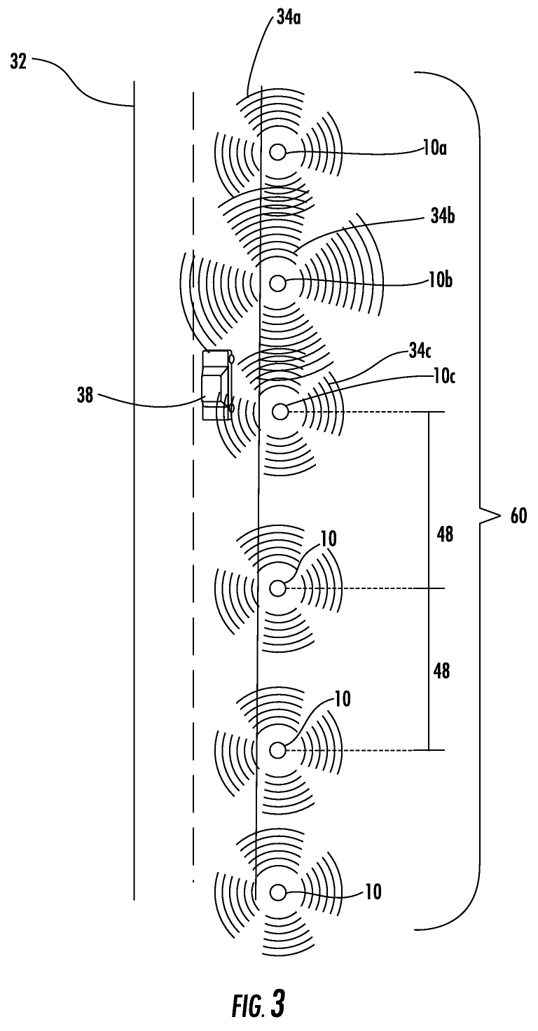

Referring now to FIG. 2A, the module 10 and/or the consumer component 20 may continuously or periodically transmit a request-to-connect signal 50. Also, the module 10 and the consumer component 20 may be configured to search for a transmitted request-to-connect signal 50. As shown in FIG. 2A, a module 10 sends a continuous request-to-connect signal 50, and the consumer component 20 receives the request-to-connect signal 50 and subsequently establishes the connection to the module 10. Alternatively, as shown in FIG. 2B, a user 56 may input a request for information command 52 using the interface 28 of the consumer component 20, after which the transceiver 22 of the consumer component 20 continuously or periodically sends a request for information signal 54. Upon receiving such a request for information signal 54, the module 10 would respond by transmitting information 40 to the consumer component 20.

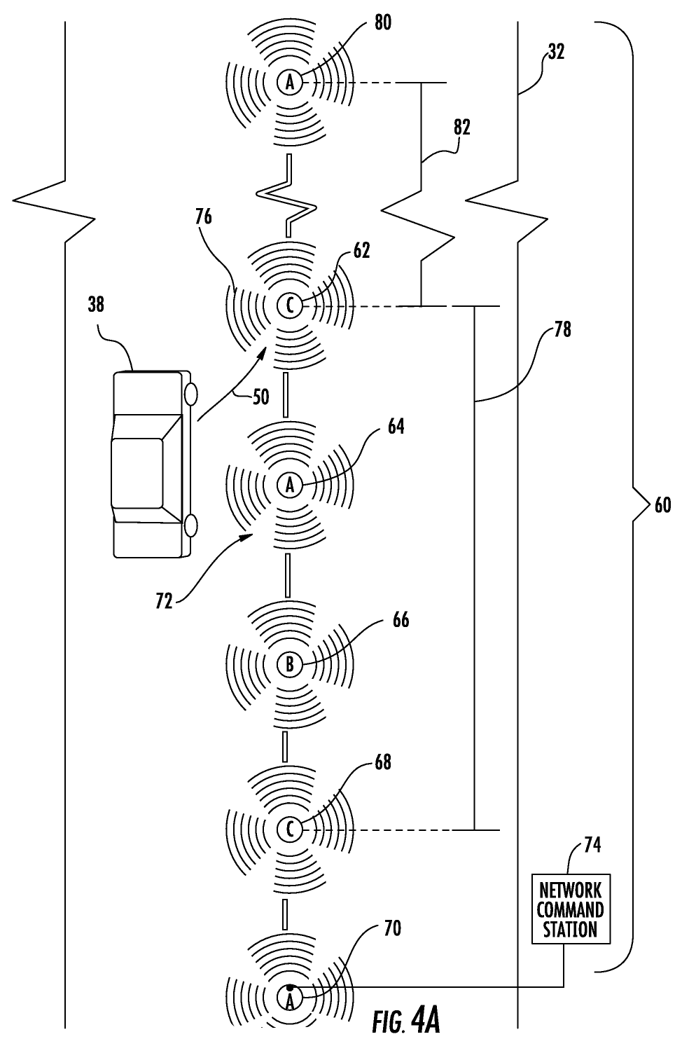

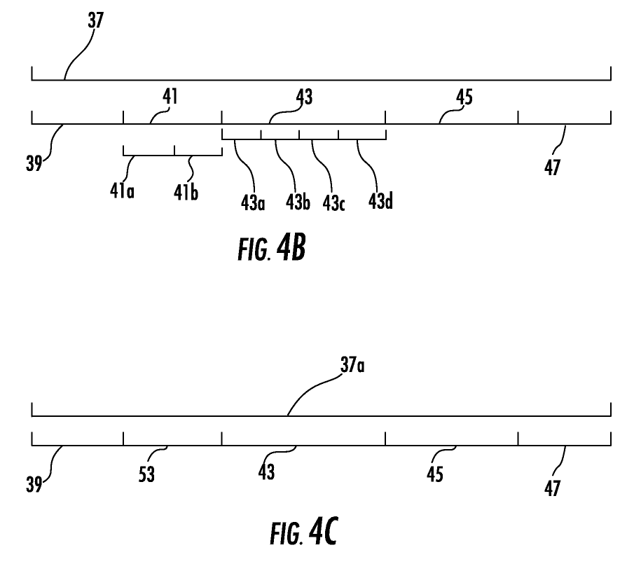

In another embodiment shown in FIG. 2C, the module 10 is constantly or periodically transmitting information 40, which may be construction information 41. roadway condition information 42, lane change information 43, weather information 44. speed limit information 45, traffic congestion information 46, and warning information 47, including accident information. In this embodiment, the consumer component 20 receives the information 40 without performing a formal connection process such as that described above. Once the transceiver 22 of the consumer component 20 receives information 40 from the module 10, the consumer component 20 displays predetermined portions 58 of such information 40 on the output 26. In some embodiments, the consumer component 20 may have a memory and store such information, thus allowing a user to toggle through portions of the information 40 displayed on the output 26 by communicating the user's choices by way of the interface 28. Furthermore, the consumer component 20 may transmit vehicle information 49 related to the vehicle 38 in which the consumer component 20 is installed. This information 49 may include direction of travel, speed and status of the vehicle, including information related to any damage to the vehicle 38. Such vehicle information 49 may be stored in the module 10 or be transmitted across the network 60 (shown in FIGS. 3 and 4) for data retrieval and analysis.

Referring now to FIG. 3, modules 10 are disposed along the transportation media 32 at periodic distances 48, or at distances such that the signals 34a from one module 10a are strong enough to be received by another module 10b. Note that the signal 34a reaches module 10b, signal 34b reaches modules 10a and 10b, and signal 34c reaches module 10b. However, for clarity of illustration, the signals 34a, 34b, and 34c are represented by lines not reaching the respective modules 10. Also note the communication of information 40 occurs when a module 10 receives a signal 34 and not when a signal 34 meets another signal 34. The distance between modules is also chosen such that the signals 34b from the second module 10b are strong enough to be received by the first module 10a. Furthermore, the modules 10 are positioned along the transportation media 32 such that a vehicle 38 moving along the transportation media 32 is always within range of at least one of the modules 10. For example, vehicle 38 depicted in FIG. 3 is traveling from the bottom to the top of the figure and is passing from signal 34c into signal 34b while maintaining constant signal reception. In other words, the distances 48 between modules 10 are preferably chosen such that the transmitting power of a module 10 is sufficient for communication with a vehicle 38 and at least one other module 10, and preferably with the two adjacent modules 10.

As shown in FIG. 4A, the communication between modules 10 and the vehicle 38 forms the information network 60. Preferably, three types of modules 10 are used in an information network 60. Each type of module 10 responds to a different frequency for communication, but preferably each module 10 in the information network 60 can transmit on any of the information network frequencies. The three types of modules are referred to as A, B, and C in FIG. 4A. Each module 10 in an information network 60 is configured such that it recognizes the types of the modules 10 disposed within its transmission range. For example, an A-type module 10 may have a C-type module 10 and a B-type module 10 within the A-type module's transmission range. Therefore, the A-type module 10 may communicate with the B-type module 10 by transmitting over the frequency corresponding to B-type modules 10 and may communicate with the C-type module 10 by transmitting over the frequency corresponding to C-type modules 10. In one embodiment, the module 10 transmitting data inserts a tag in the data to indicate the origin of the data communication (see FIG. 4B). Preferably, all types of modules, A, B, and C, can communicate over outside frequency bands with extra-network devices. However, within the frequency band containing the three frequencies corresponding to types A, B, and C, the modules 10 preferably transmit and receive only at the three specified frequencies. In other words, the modules 10 communicate over a predetermined frequency band containing three specific module transmission frequencies for intra-network communications, but the modules may also send and receive inter-network communications over frequency bands not specified for network usage.

Referring now to FIG. 4B, an embodiment of a data communication 37 sent from a module 10 is shown where the horizontal axis represents time. The modules 10 and the consumer components 20 analyze data communications 37 section by section. The data communication 37 is broken into five sections which include a start code 39, flags 41, a data section 43, a second data section 45, and a stop code 47. In one embodiment, the data section includes a data start code 43a, a description 43b, data 43c, and a data stop code 43d. The start code 39 indicates the beginning of the data communication 37. The flags 41 indicate parameters specific to the data communication 37 such as data type or length of the data communication 37. The flags section 41 may include an accident report flag 41a, an emergency vehicle flag 41b, or others. The data section 43, in this embodiment, begins with a data start code 43a for indicating the start of the data section 43. The description 43b indicates the type of data contained in this particular data section 43 and the module 10 or consumer device 20 interprets the description 43b and processes the data accordingly. The data 43c follows the description 43b, and the data section 43 ends with a data stop code 43d. The data 43c may constitute a wide variety of things including GPS coordinates, car identification number or email message. The data start code 43a and the data stop code 43d distinguish among data sections in a lengthy data communication 37 or in this example, between the data section 43 and the second data section 45. The data start code 43a and the data stop code 43d also distinguish the data section 43 from the other portions of the data communication 37.

A data communication 37 may be a module-to-module communication 37a, a module-to-consumer communication 37b or a consumer-to-module communication 37c. All three types of data communications 37 are preferably configured as shown in FIG. 4B. However, a module-to-module transmission 37a, as shown in FIG. 4C, may also include a module origination section 53. The module origination section 53 indicates from which module 10 the module-to-module transmission 37a was sent. Alternatively the module origination section 53 may be included in either the flags 41 or a data section 43.

As used herein, the term upstream refers to the direction from which traffic is generally approaching. For example, from the perspective of a module 10, upstream is the direction from which traffic approaches the module, or in other words, upstream is the opposite direction as traffic is moving. Conversely, the term downstream refers to the direction in which traffic is generally moving toward. For example, from the perspective of a module 10, downstream is the direction to which traffic is approaching as it passes the module 10, or in other words, downstream is the same direction as traffic is moving.

When a module 10 receives a communication from outside the information network 60, the module determines which direction along the information network the information should be transmitted. In general terms, if an event such as a car accident is communicated to a module 10, the module may be programmed to transmit such information 40 along the information network 60 upstream along the transportation media 32 so that drivers of vehicles 38 become aware of accident circumstances before entering a situation requiring spontaneous reactions such as extreme braking in order to decelerate immediately. Similarly, if an ambulance is approaching from upstream and is attempting to bypass traffic quickly, the information network 60 may transmit information 40 downstream to alert drivers to move aside for the ambulance.

As shown in FIG. 4, an A-type module 64 receives an emergency vehicle signal 72, such as a signal from a transmitter located in an ambulance, and module 64 determines the type of signal 72 it has received. Upon determining the signal 72 is an emergency vehicle signal to be transmitted downstream, the module 64 transmits the signal 72 in all direction on the frequency corresponding to the next downstream module 10, which is C-type module 62. Preferably, A-type module 64's transmission power is strong enough to communicate with C-type module 62 and B-type module 66 but not C-type module 68 or any other modules 10. C-type module 62, upon receiving the information sent from A-type module 64, will recognize the information as emergency information needing to be sent downstream and will send such information 40 downstream to the next module 10. This progression of information distribution through the network occurs very quickly and therefore allows vehicles 38 nearing an accident scene to be aware of any dangers they are approaching. This fast progression of information also alerts any vehicles 38 downstream of an ambulance or other emergency vehicle to move out of the path of the ambulance or emergency vehicle as quickly as possible.

With continued reference to FIG. 4, vehicle 38 equipped with a consumer component 20 sends a request to connect signal 50 as the vehicle travels from the bottom of the figure to the top. As described above, the C-type module 62 receives the request to connect signal 50 and forms a connection 30 between the consumer component 20 and the C-type module 62. Assuming an emergency vehicle signal entered the network upstream of vehicle 38 and the information from such signal has been relayed to C-type module 62, C-type module 62 will transmit such information 40 in the form of an information transmission 76 to the vehicle 38. The information transmission 76 may include such facts as the distance between the vehicle and a downstream accident and the distance between an approaching, upstream emergency vehicle and the vehicle 38. Furthermore, the information 40 may include estimated times of arrival of the vehicle 38 at the accident scene and of the upstream emergency vehicle interception of the vehicle 38 on the transportation media 32. Alternatively, the consumer component 20 may receive the information transmission 76 including emergency information 40 and calculate the estimated time of arrival at the accident scene based in part on the present velocity of the vehicle 38.

As shown in FIG. 4, the modules 10 are disposed on the transportation media 32. The modules 10 may be incorporated in a reflection device along the middle of the transportation media 32, may be disposed below the surface of the transportation media 32, or may be disposed on top of the transportation media 32 and be reinforced and shaped such that vehicles 38 traveling at high speeds may safely pass over the modules 10. Such a configuration allows the modules 10 to be in closer proximity with vehicles 38 on the transportation media 32. In FIG. 4, several modules 10 are arranged on the transportation media 32 to create an information network 60. The information network 60 is configured for various purposes such as distribution of information 40 and collection of information 40. Preferably, distribution and collection of information 40 by the information network 60 is to and from vehicles 38. However, the information network 60 may distribute information 40 to other receivers such as receivers carried by pedestrians or people riding bicycles. Furthermore, the information network 60 may collect information 40 from other transmitters such as transmitters associated with an emergency information network or a network command station 74, as shown in FIG. 4.

As information 40 is relayed along the information network 60, the modules are aware of their positions relative to each other and are able to determine the subject matter of the information 40. For example, if an accident occurs near C-type module 62 and a consumer component 20 transmits information detailing the accident to C-type module 62, then C-type module 62 will associate the accident with an origin marker and may store the origin marker in the memory 18 of the C-type module 62. Such an origin marker is preferably associated with a known location along the transportation media 32. For example, if C-type module 62 is located on or near a mile-marker, the origin marker will be associated with that specific mile marker. In one embodiment, this is accomplished by storing data in the memory 18 of the module 10 characterizing the mile markers nearest the module 10. In such embodiment, the module 10 may create the origin marker based on the data characterizing the mile marker. Next, the information 40 sent from the consumer component 20 regarding an accident will be characterized either by the consumer component 20 or the module 10 to determine an upstream notification distance 78 and a downstream notification distance 82. For example, the module 10 may be programmed to alert 100 modules 10 upstream for a one car accident. When the module 10 receives a signal from a consumer component 20 indicating a one-car accident, the module 10 would determine the upstream notification distance 78 is 100 modules 10.

In one embodiment, the upstream notification distance 78 would be one mile. Thus, the information 40 would be transmitted upstream from module to module until the information reached the module located closest to one mile upstream from the origin marker. In one embodiment, the modules are positioned at about a one hundred foot distance from one another. In such a configuration, the information 40 would be transmitted to the fifty-third module upstream from the origin marker. In other embodiments, the information network 60 may be configured to transmit information 40 to the closest module that is equal to or greater than the upstream notification distance 78 and the downstream notification distance 82 from the origin marker. Similarly the information network 60 may be configured to transmit information 40 to the closest module that is equal to or less than the upstream notification distance 78 and the downstream notification distance 82 from the origin marker.

In another embodiment, when the information network 60 determines an upstream notification distance 78 of, for example, two miles, the module 10 where the information 40 originates, for example C-type module 62 determines a counter 84 that accompanies or is embedded into the information 40 before it is transmitted upstream. The counter 84 is representative of the upstream notification distance 78. For example, if each module 10 is 100 feet apart and the upstream notification distance 78 is two miles or 10,560 feet, the module 10 forms a counter 84 that will expire at the 105^{th} or the 106^{th} module 10 upstream in the network 60. The network 60 may be programmed such that it knows whether to overshoot or undershoot the notification distances 78 and 82.

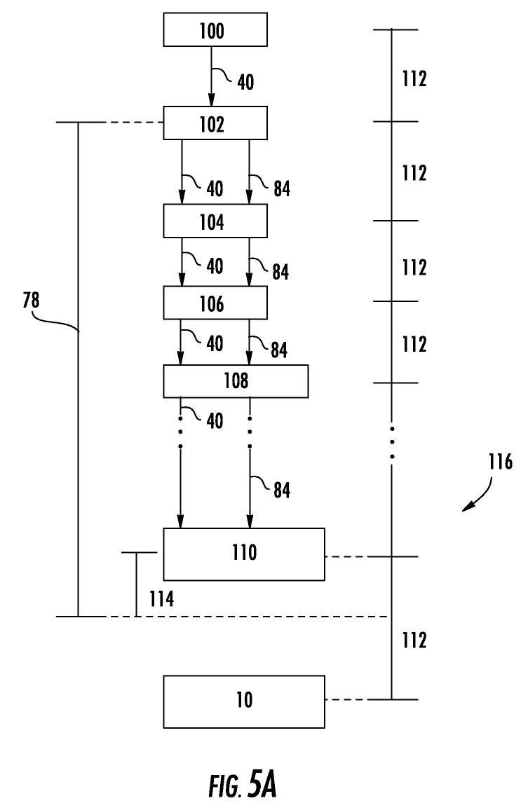

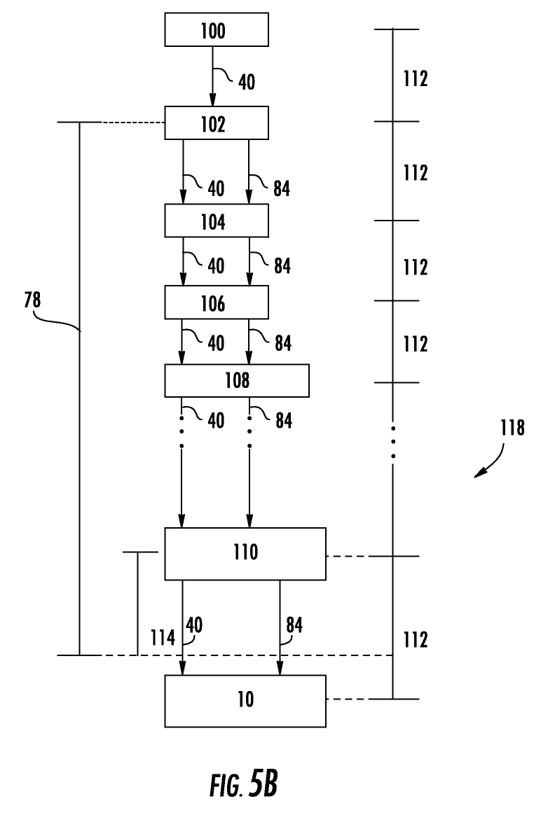

Referring to FIG. 5A, block 100 represents a source of information 40, originating from a network station, a module, an emergency vehicle, another vehicle, or some other source. The information 40 is received by a module 102. Module 102 determines the necessary notification distance, 78 or 82 (the upstream notification distance 78 is shown in FIG. 5A) based on predetermined criteria programmed in each module 10. In the case where the network 60 is programmed to undershoot the notification distances 78 and 82, an undershoot network configuration 116 is implemented as shown in FIG. 5A. In an undershoot network configuration 116, the origin module 102 divides the notification distance 78 or 82 by the distance between modules 10, which is represented by module distance 112 if the distance between modules is substantially constant. The origin module 102 then rounds down to a whole number in order to determine the value of the counter 84.

Alternatively, if the network 60 is programmed to overshoot the notification distances 78 and 82, an overshoot network configuration 118 is implemented as shown in FIG. 5B. In an overshoot network configuration 118, the origin module 102 divides the notification distance 78 or 82 by the distance 112 between modules 10 and then rounds up to a whole number in order to determine the value of the counter 84.

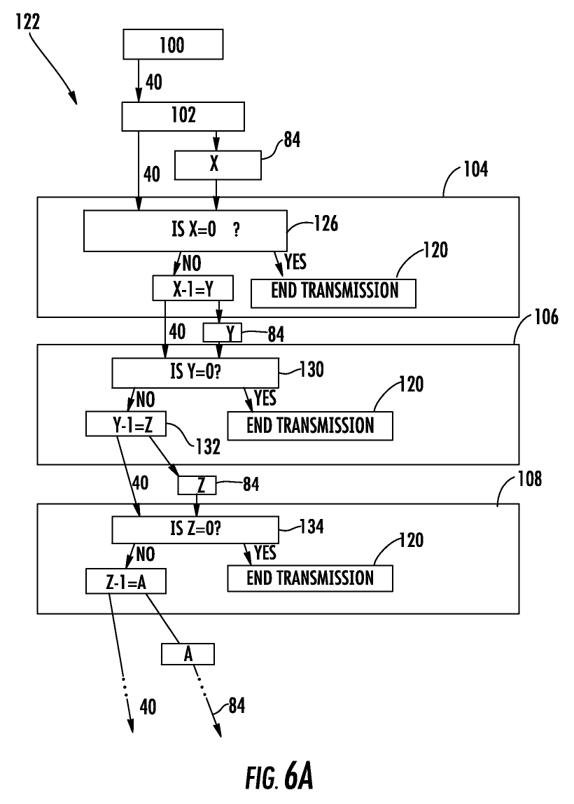

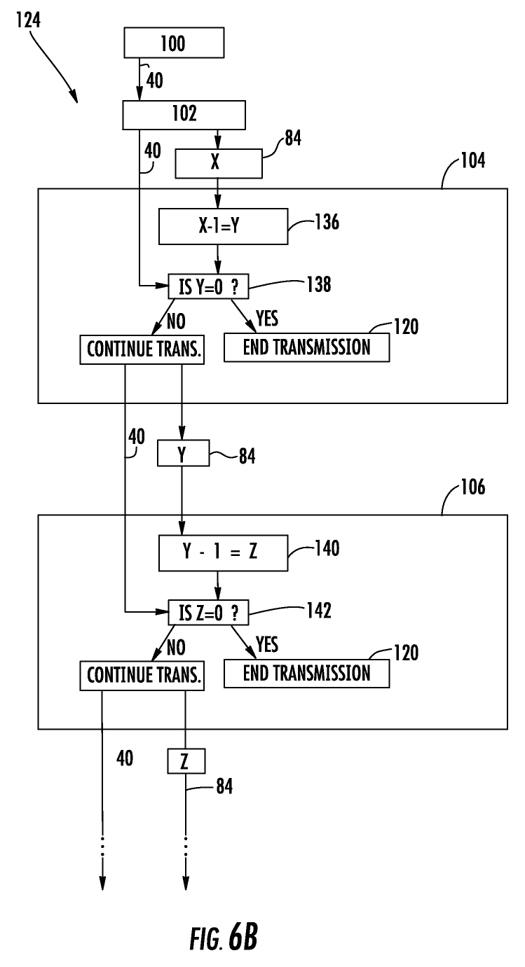

Once the information 40 and the counter 84 are transmitted from the origin module 102, the next module 104 receives the information 40 and reduces the counter 84 by one before sending the information to the next upstream module 106. The process is repeated until an end transmission event 120 occurs (as shown in FIGS. 6A and 6B). An end transmission event 120 is defined differently depending on whether the network 60 is configured as a receive zero stop network 122 or a receive one stop network 124. These network types 122 and 124 are discussed below and are shown in FIG. 6.

In a network 60 where the modules 10 are equidistant from one another, each module 10 on the network 60 is programmed with the distance from one module 10 to the next. In such a configuration, the module distance 112 is a substantially accurate representation of the distance between adjacent modules 10. Thus, origin module 102 determines a counter 84 by dividing the upstream notification distance 78 by the module distance 112. This calculation yields the counter 84, which represents the number of modules 10 to which the information 40 will be transmitted. Referring back to FIG. 5A, origin module 102 preferably sends the counter 84 embedded in the information 40 to the next upstream module 104. Module 104 receives the information 40 and the counter 84 and reduces the counter 84 by one. Module 104 then checks the counter 84 to see if it equals zero. If the counter 84 equals zero, module 104 will not retransmit the information 40 or the counter 84. In the case of an undershoot network configuration 116 as discussed above, when the counter 84 reaches zero, the information will have been transmitted to every module between the originating module 102 and the terminating module 110. As shown in FIG. 5A, the upstream notification distance 78 extends beyond the terminating module 110. However, it extends past the terminating module 110 a distance 114 that is less than the module distance 112. This is representative of an undershoot network configuration 116.

Referring now to FIG. 6A, a block diagram illustrating a receive zero stop 122 network configuration is shown. Block 100 represents a source of information 40. Block 102 represents an origin module which receives the information 40, formulates a counter 84 based at least in part on a notification distance 78 or 82, and transmits the information 40 with the counter 84. In this illustration,

After receiving the information 40 and the counter 84, module 106 determines whether Y is equal to zero, which is represented by block 130. Similar to the process described above with regard to module 104, if Y is equal to zero, module 106 will not transmit the information 40 and the counter 84. In other words, module 106 is the final module 10 in the network 60 to receive the information 40. If module 106 determines Y is not equal to zero, then module 106 subtracts one from Y, resulting in Z. This is represented by block 132. Module 106 then transmits the information 40 and the counter 84, which has a value of Z, to the next module 10 in the network 60, which is module 108. This process of transmission of information 40 and counter 84 proceeds until a module 10 receives a counter 84 that the module 10 determines is equal to zero. This configuration is referred to as the receive zero stop configuration 122 because the transmission stops when a module 10 in the network 60 receives a counter 84 equal to zero.

The receive one stop 124 network configuration is very similar to the receive zero stop configuration 122 described above. The receive one stop configuration 124 may be implemented by following a procedure identical to that illustrated in FIG. 6a except that blocks 126, 130, and 134 would read “IS X=1?,” “IS Y=1?,” and “IS Z=1?,” respectively. Such a configuration still constitutes a receive one stop configuration 124.

Referring to FIG. 6B, a block diagram illustrating an alternative embodiment of a receive one stop 124 network configuration is shown. The difference between this embodiment and those described above is the configuration of FIG. 6B reduces the counter 84 before determining whether the counter 84 is zero. At the top of the figure, block 100 represents a source of information 40. Block 102 represents an origin module which receives the information 40, formulates a counter 84 based at least in part on a notification distance 78 or 82, and transmits the information 40 and the counter 84. In this illustration, the counter 84 is assigned as original value of X by origin module 102. The next module 104 in the network 60 receives the information 40 and the counter 84. Block 136 represents a calculation performed by module 104 wherein the value of Y is determined by “Y=X−1.” Module 104 then determines whether Y is equal to zero, which is represented by block 138. If Y is equal to zero, the transmission is ended. If Y is not equal to zero, module 104 transmits the information 40 and the counter 84, which has a value of Y, to the next module 106 in the network 60.

Module 106 receives the information 40 and the counter 84. The counter 84 is reduced by one, which is represented by block 140, and the counter value is represented by Z. Next, module 106 determines whether Z is equal to zero, in which case the transmission is ended. If Z is not equal to zero, the transmission is continued by module 106 transmitting the information 40 and the counter 84, which has a value of Z. This process is continued until a module 10 on the network 60 determines that, after reducing the counter 84 by one, the counter 84 is equal to zero. This configuration is called a receive one stop configuration 124 because when a module receives a counter with a value of one, it will reduce it by one, determine the counter 84 is equal to one, and end subsequent transmissions.

In another embodiment, in addition to the counter 84, an original value 144 of the counter 84 is transmitted by embedding it in the information 40 or the counter 84. This allows each module 10 on the network 60 to determine the number of modules 10 between itself and the origin module 102. Each module 10 can also determine the distance between itself and the origin module 102 by multiplying the original value 144 of the counter 84 by the module distance 112. Similarly, the module 10 can determine the distance remaining in the notification distance 78 or 82 by multiplying the value of the counter 84 by the module distance 112. These distances are beneficial for various applications. For example, a module 10 would be able to warn vehicles 38 entering its transmission range on the transportation media 32 how far downstream is the location of an accident or other event requiring a driver's attention. Preferably, such a warning would stay in effect until the network 60 receives a stop information signal 146 from a network station 74, another module 10, or some other source with authority, such as the Department of Transportation, the police, or an emergency service.

In the situation where two modules 10 receive the same warning signal, for example from a consumer component 20 informing the network 60 of an accident on a transportation media 32, both modules 10 send the information 40 to the notification distance 78 or 82 determined by the modules 10. Preferably, the modules 10 are programmed similarly, and would therefore calculate notification distances 78 or 82 that are equal. Thus, the modules downstream or upstream which receive information 40 from an origin module 102 discard any information 40 duplicating information 40 already received from another module 10, if the information 40 from the origin module 102 has a lower number counter 84 than the counter 84 associated with the duplicated information 40. This allows the information 40 associated with the highest counter 84 to continue upstream or downstream in order to achieve a maximum warning distance. However, if the duplicating information 40 has a higher counter, it is passed along upstream or downstream to the next module 10. Information 40 regarding stationary events such as an accident is preferably continuously or periodically transmitted from the modules 10 within the notification distance 78 or 82 until the modules 10 are instructed by an authority, such as DOT, to cease transmission. Alternatively, if information 40 is transmitted regarding an approaching emergency vehicle, the information 40 is preferably only transmitted once from a specific module 10 because the emergency vehicle is moving and the content of the information 40 is changing over time. However, information from another module 10 with updated distance and time-to-intercept calculations is sent in order to provide accurate data to downstream consumer components 20 connected to the network 60.

In one embodiment, the network 60 includes network stations 74 as shown in FIG. 4. Network stations 74 may be located at a periodic distance from one another, but are preferably located at a greater distance than the module distance 112. Referring to FIG. 7, the distance between network stations is referred to as the network station distance 148. Network station 150 is located in between modules 102 and 104, network station 152 is located in between modules 106 and 108, and network station 154 is located near module 110. In one embodiment, each of the adjacent network stations 150, 152, and 154 are separated from one another by a distance equal to the network station distance 148. In another embodiment, the network stations 74 may be separated from one another by different distances. In another embodiment, the network stations 150, 152, and 154 are located such that they may communicate with multiple modules 10. But in other embodiments, the network station 74 may be located at the same location as a module 10. In other embodiments, the network station 74 may not be at the same location as a module 10 and may only be capable of communication with at least one module 10. In such a case, the module 10 would relay to the rest of the network 60 any communication received from a network station 74.

Preferably, the network stations 150, 152, and 154 are connected to each other either wirelessly or by wire. Furthermore, the network stations 150, 152, and 154 are preferably connected to a central location by wireless or hardwired connections. Such connections could also include connections over the Internet or radio, such as cellular phone technology. Some authority, such as those listed above or others, may have control over the network 60. Also, the network stations 150, 152, and 154 may have additional functionality, such as additional sensors to monitor the transportation media 32 for events such as accidents and traffic. Also, the network stations 150, 152, and 154 may provide notification to vehicles 38 on the transportation media 32 of the necessity of lane change or speed limit change.

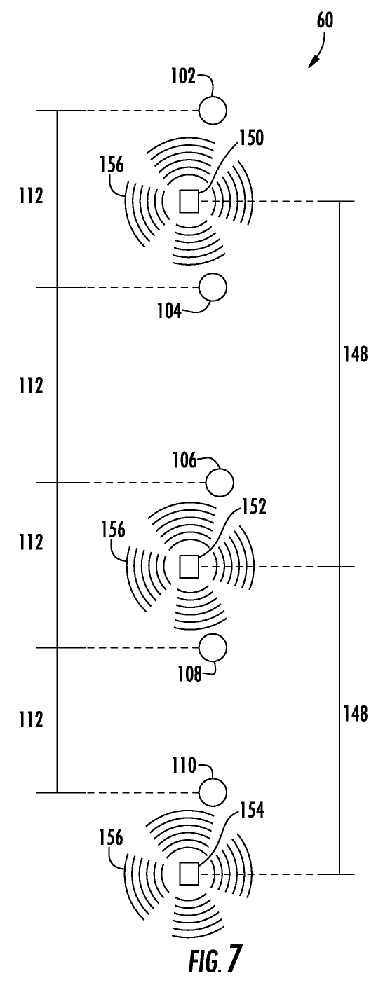

Preferably, modules 10 in the information network 60 are connected to network stations 74, which are also connected to a central location, which is preferably a server 158 as shown in FIG. 8. The server 158 or group of servers 158 are also preferably connected over the Internet 162 via Internet server 160, which could be one of the servers 158 in some embodiments. The Internet server's 162 connection to the Internet 160 preferably is used to compile data such as traffic or accident data. A benefit of providing such data on the Internet 162 is the ability for users to proactively search for data, for example searching for data relating to a trip someone is planning to make. Such data is nearly real-time as it is uploaded onto the Internet 162 as soon as it is received by the servers 158. One example of the use of this functionality is a person who is planning to drive home from work starts a program on a computer that is connected to the Internet 162. The program has been pre-programmed with the person's work location and home location, and using the module network 60, indicates to the person the preferred route from work to home, that is, the route estimated to be the quickest route based on traffic density, speed limits and other criteria. Alternatively, a vehicle's navigation system may also function as the interface between the person and the network 60. In this case, the navigation system is connected to the consumer component 20, meaning it could receive this data from the network 60, or directly to the Internet 162 in order to receive real time updates on road conditions and traffic.

In one embodiment, the network station 74 receives information 40 from an authority source by way of a server 158. Such information may include data indicating the necessity for a lane change at a particular location if, for example, road construction is scheduled that day for a particular time. The lane change notification may be sent to a network station fifteen minutes before the work crew arrived on scene so that the work crew could cordon-off the necessary portion of the lane safely and efficiently. The module 10 receiving the information 40 from the network station 150, 152, or 154 formulates a notification distance 78 or 82 (if one was not provided by the network station 150, 152, or 154) and transmits the information 40 on the network as described above. In preferred embodiments, the network stations 74 are in communication with an authority such as the Department of Transportation (“DOT”) via a server 158 which is capable of contacting DOT if a module is non-responsive or is having any type of problem.

In another embodiment, the servers 158 are maintained and operated by the DOT. Furthermore, the network stations 74 may gather data such as the number of messages of information 40 relayed, the types of information 40 relayed, and the number of vehicles 38 that have connected to each module 10. Additionally, the configuration shown in FIG. 8 allows the network 60 to receive updates and programming from an authority such as DOT. Also, the configuration provides a network 60 that is dynamic rather than static, that is, a network 60 which may adapt to changing situations such as ending a communication indicating an accident once the accident site has been cleared. In one embodiment, the consumer components 20 have Internet access via a connection with the module network 60. Such real time access allows the consumer components 20 to provide the user with up-to-date road maps downloaded from the network 60 such as from the modules 10 or servers 158.

Each network station is preferably programmed with the transmitting capabilities of every module 10 within the network station's transmission region. This allows the network station 74 to calculate the distances between itself and every module 10 and also the distance between every module 10 to every other module 10. From these distances, the network station 74 compiles tables and sends the tables to each module 10. Thus, each module 10 stores the distances from itself to each other module 10 within transmission range. The distance table may include a module identification number specific to each module 10 surrounding a particular module 10 and a distance corresponding to the combination of a module 10 and each module surrounding it. Alternatively, the table may include a counter 84 (see FIGS. 5 and 6). Therefore, a module 10 may easily transmit the distance from a consumer component 20 to an event such as an accident or an emergency vehicle approaching.

The network stations 150 may also be used in other ways. For example, when vehicle information 49 that was sent from a vehicle 38 to a module 10 and subsequently to a network station 150 includes accident information or other critical emergency information, the network station, through its connection with an authority such as DOT, could inform emergency services of the accident. For example, an alert regarding the accident could be sent from the network station 150 to a fire department, a police department, or a hospital, where the alert reports the apparent severity of the accident (based on the consumer component's ability to determine damage to the vehicle 38), and the location of the accident.

In the case where an emergency vehicle is moving downstream and the network 60 is transmitting information downstream in the network 60, the modules 10 are preferably programmed to cease transmission of the emergency information after a predetermined period of time. Alternatively, the modules 10 may receive information 40 from the emergency vehicle as it passes the module 10, such information informing the module to cease emergency transmission. Such a system reduces the possibility of an inaccurate emergency signal broadcast over the network 60. In another embodiment of the network 60, the modules 10 are programmed to continue transmission until an authority communicates a stop transmission signal to a network station 150, which re-transmits such stop transmission signal to the modules 10 on the network 60. Such an embodiment is preferably used for information 40 related to events such as accidents which continue for an indefinite period of time.

In other embodiments, the network stations 74 and the modules 10 may be used to pass on non-roadway information 156 such as advertisements relating to local commercial establishments or historical information about the area. In such an embodiment, the consumer component 20 may be a handheld device such as a PDA or a cellular phone which would receive the non-roadway information 156 from the modules 10 or a network station 74 and process and display such information so that a driver or passenger in a vehicle or a pedestrian may use the non-roadway information 156. Furthermore, billboards and road-signs may include modules 10 or network stations 74 which provide similar advertising information. In another embodiment, every vehicle 38 transmits a unique signature within the designated frequency and network stations 74 log data regarding the vehicles 38. Such a system may be helpful in locating stolen vehicles, recreating crime scenes or other events, or a wide array of other uses.

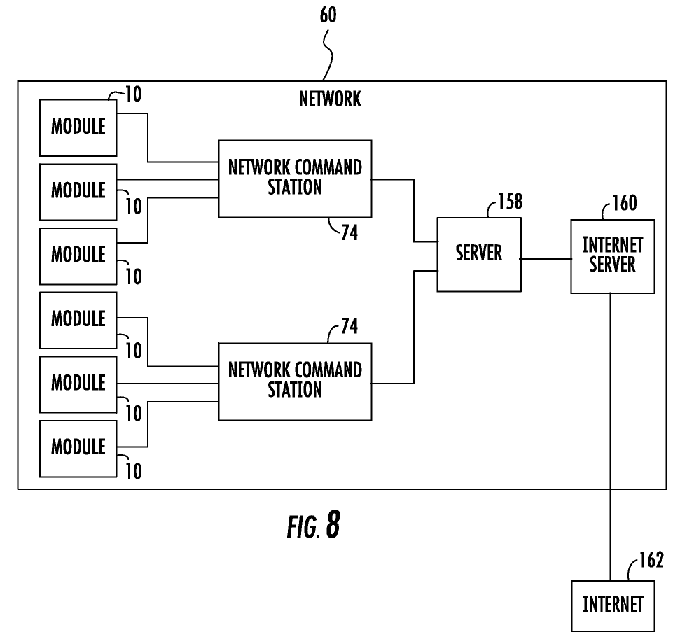

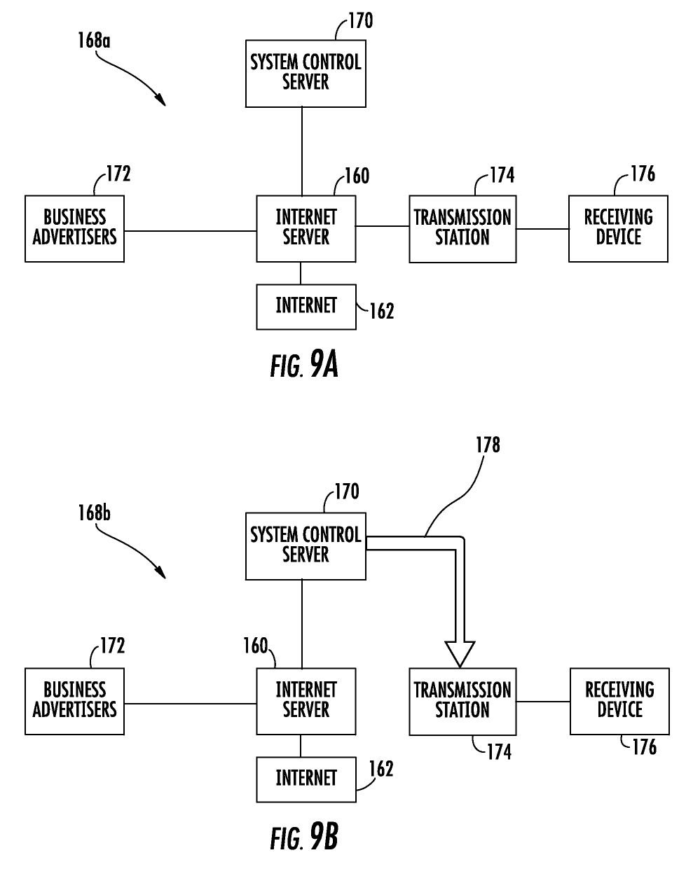

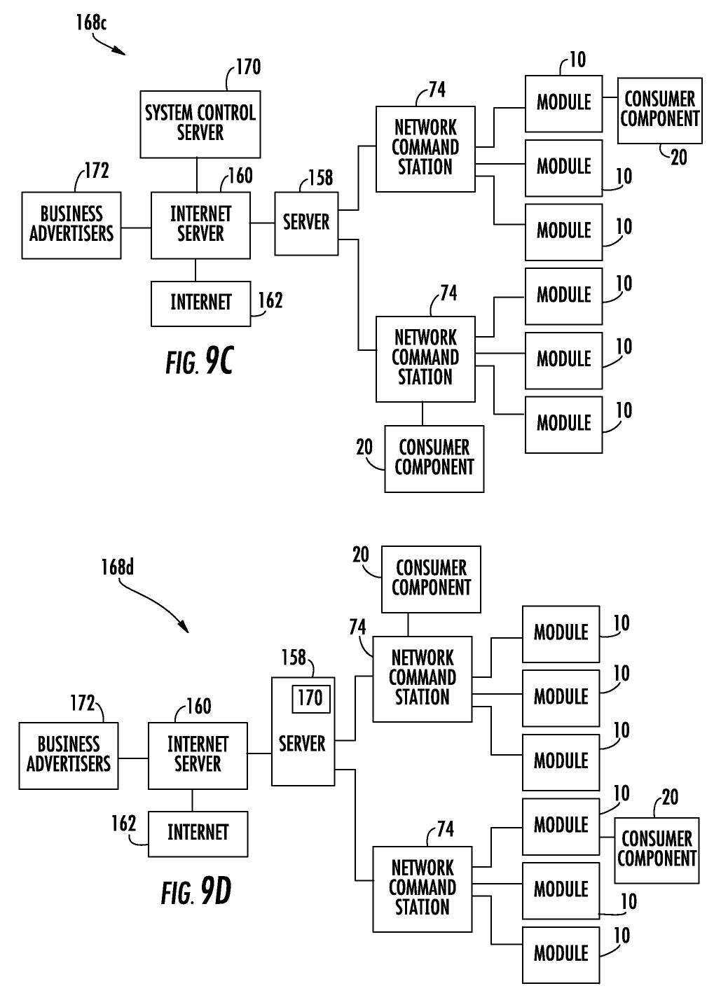

Referring to FIG. 9A, one embodiment of an advertising network 168a is shown. Business advertisers 172 gain access to the system control server 170 by way of the Internet server 160, which is connected to the Internet 162. An advertiser 172 can access a web-page interface allowing it to choose a category under which its business fits. Additionally, an advertiser 172 enters information describing the business such as a phrase or daily special. Also, the advertiser 172 chooses the transmission station 174 to host advertisements for the business. This is done by accessing an interactive map on the interface whereby the advertiser 172 may choose which transmission station(s) 174 to use. Advertisers 172 may choose only one or several transmission stations 174 and charges are applied to the accounts of the advertisers based on the number of transmission stations 174 used. The transmission stations 174 engage the receiving device 176, which in some embodiments may be the consumer component 20 as shown in FIGS. 9C and 9D.

Referring now to FIG. 9B, one preferred embodiment of an advertising network 168b is shown. A secondary communication channel 178 connects the system control server 170 to the transmitting station 174 in this embodiment. As in FIG. 9A, the receiving device engages the transmission station 174 and may be a consumer component 20 as shown in FIGS. 9C and 9D. The secondary communication channel 178 is used to update the transmitting station 174 in a case where the transmitting station 174 is not connected to the Internet 162 via an Internet server 160. Satellite communication as well as radio communication may be used to implement the secondary communication channel 178. The transmission stations 174 may receive the advertising information several ways including as a communication including all the advertisements for a large area. In this case, the transmission station 174 filters all of the advertisements not intended for that particular transmission station 174. Another way the advertising information may be transmitted is by cellular phone tower. The transmitting stations 174, in such an embodiment, must be capable of transmitting and receiving cellular telephone calls, which would be used to download data from the system control server 170.

Referring now to FIG. 9C, another preferred embodiment of the advertising network 168c is shown. In this preferred embodiment, the system control server 170 is connected to the Internet server 160, which is also connected to both the Internet 160 and the business advertisers 172. The Internet server 160 is further connected to the server 158 previously described in FIG. 8. This server 158, as described above, is connected to several network command stations 74. The network command stations 74 are furthermore connected to several modules 10. In this embodiment, either the network command stations 74 or the modules 10 may communicate with the consumer components 20. As noted regarding FIGS. 9A and 9B above, the consumer components 20 may be other types of receiving devices 176.

Referring now to FIG. 9D, another preferred embodiment of the advertising network 168d is shown. The business advertisers 172 are connected to the Internet server 160, which is also connected to the Internet 162. The Internet server 160 is connected to the server 158 as discussed above with regard to FIG. 8. The server 158 is also connected to several network command stations 74. The network command stations 74 are each connected to several modules 10. A consumer component 20 may engage either the modules 10 or the network command stations 74 as discussed above.

Thus, the system control server 170 of FIGS. 9A, 9B, and 9C may be part of the server 158 or may be server 158 as shown in FIG. 9D. Furthermore, network command stations 74 and modules 10 may be part of the transmission stations 174 (FIGS. 9A and 9B) or may be the transmission stations 174 (FIGS. 9A and 9B). Also, as discussed above, the receiving device 176 (FIGS. 9A and 9B) may be the consumer component 20 as shown in FIGS. 9C and 9D, or the consumer component 20 may be part of the receiving device 176.

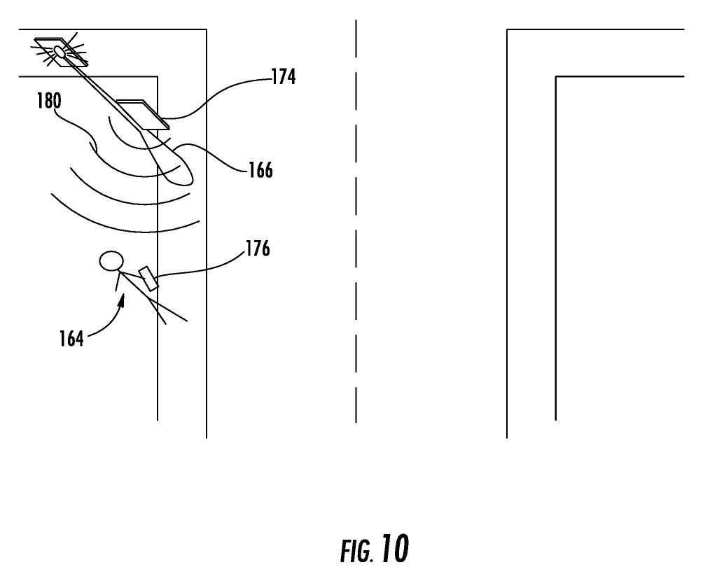

Referring now to FIG. 10, a diagram of a city intersection is shown including a transmission station 174 attached to a light fixture 166. The transmission station 174 is transmitting an advertising message 180 which is received by a receiving device 176 carried by a pedestrian 164. Before the message 180 is transmitted, however, other steps must occur. Once business information has been entered by the advertiser 172 and the advertiser 172 has paid the system administrator for the advertising, the system control server 170 sends the advertisement information to the transmission stations 174 selected by the advertiser 172. The transmission stations 174 preferably are positioned to maximize effective advertising in locations such as alongside roadways, off-ramps to highways and interstates, intersections, and subway depots. The messages 180 transmitted by the transmitting stations cycle periodically, repeating the information describing each advertiser 172 included in the messages 180. The receiving device 176 preferably is a consumer component 20 such as a PDA, cellular phone, car component such as a navigation system, or other consumer component 20.

The receiving device 176, which may be a consumer component 20, wirelessly receives the advertising message 180 sent from the transmission station 174. Preferably. the consumer component 20 processes the advertising message and displays it in human readable format on the display of the consumer component 20. Preferably, the consumer component 20 has an on screen guide for navigating through the advertising information. The guide uses a menu listing available categories such as restaurants, clothing stores, bars, or others. The user selects a category, and the listing included in the selection are displayed. In one embodiment, the consumer component uses GPS navigation to direct the user in the direction of the business. This is accomplished by retrieving stored GPS coordinates corresponding to the business, which were entered when the business advertiser 172 established the advertisements, and using mapping software to determine the directions from the consumer component's location to the business location. In another embodiment, the consumer component 20 uses mapping software that stores the names and information corresponding to businesses including location in its memory for future reference.

In another embodiment, advertisers 172 purchase the option of being able to modify their advertisement information in real time. That is, an advertiser 172 updates the business information by uploading such information on the web page interface and the updated information is contemporaneously transmitting to the transmission stations 174, which transmit up-to-date messages 180 to consumer components 20. For example. if a fast-food restaurant decided to have a special on a specific day of the week, a manager of the restaurant may log on to the web page interface run by the system control server 170 and upload the restaurant's information regarding the sale. Furthermore, Internet hyperlinks and multimedia may be included in the advertisement regarding the special or in any other advertisement.

The foregoing description of preferred embodiments for this invention has been presented for purposes of illustration and description. It is not intended to be exhaustive or to limit the invention to the precise form disclosed. Obvious modifications or variations are possible in light of the above teachings. The embodiments are chosen and described in an effort to provide the best illustrations of the principles of the invention and its practical application, and to thereby enable one of ordinary skill in the art to utilize the invention in various embodiments and with various modifications as are suited to the particular use contemplated. All such modifications and variations are within the scope of the invention as determined by the appended claims when interpreted in accordance with the breadth to which they are fairly, legally, and equitably entitled.

What is claimed is:

1. A traffic information system for communicating with a driver of a vehicle, the traffic information system comprising:
a. a consumer component associated with the vehicle, the consumer component having:
i. a component communication device for receiving outside information and transmitting vehicle information,
ii. an interface connected to the component communication device for receiving input from the driver, and
iii. an output connected to the component communication device for displaying at least one of the outside information and the vehicle information in a human readable format, and
b. a plurality of modules forming a network wherein each of the plurality of modules is in communication with at least one other module, and is operable to communicate with the consumer component, the modules each having:
i. a module communication device for receiving outside information, transmitting the outside information to the component communication device and receiving vehicle information from the component communication device,
ii. a processor connected to the module communication device for processing the outside information and the vehicle information, and
iii. a memory connected to the processor.

2. The traffic information system of claim 1 wherein one or more of the modules are programmed in one or more of an undershoot network configuration, an overshoot network configuration, a receive zero stop configuration and a receive one stop configuration.

3. The traffic information system of claim 1 wherein the outside information comprises advertising information.

4. The traffic information system of claim 1 wherein one or more of the modules communicate with the consumer component substantially on one frequency within the Industry, Scientific and Medical (“ISM”) Band.

5. The traffic information system of claim 1 wherein the outside information comprises an emergency vehicle upstream signal transmitted by an emergency vehicle consumer component associated with an emergency vehicle.

6. The traffic information system of claim 1 wherein the outside information comprises an accident downstream signal.

7. The traffic information system of claim 1 wherein the vehicle information comprises a vehicle velocity having a speed component and a direction component.

8. The traffic information system of claim 1 wherein the vehicle information comprises a vehicle incident signal indicating that the vehicle has been involved in an emergency situation.

9. The traffic information system of claim 1 wherein at least one of the modules determines a location of the vehicle based at least in part on a location of a module that first receives the vehicle information from the consumer component.

10. The traffic information system of claim 1 wherein one or more of the modules determines retransmission information selected from the group consisting of outside information and vehicle information, the retransmission information to be transmitted to one or more selected from the group consisting of an upstream module, a downstream module, the consumer component, a second consumer component, and a network station.

11. The traffic information system of claim 1 wherein, upon receiving one of the vehicle information and the outside information, a first module determines whether one of the vehicle information and the outside information comprises a downstream incident signal, in which case the first module determines a downstream notification distance corresponding to the downstream incident signal.

12. The traffic information system of claim 11 wherein the first module transmits the downstream incident signal to a second module that is downstream of the first module in the network of modules.

13. The traffic information system of claim 11 wherein the first module determines a counter based at least in part on the downstream notification distance and transmits the counter to a second module that is downstream of the first module in the network of modules, the counter for indicating to the second module whether to transmit the downstream incident signal to a third module that is downstream of the second module in the network of modules.

14. The traffic information system of claim 1 wherein at least a first module of the plurality of modules receives communications on a first frequency within the Industry, Scientific and Medical Band and at least a second module of the plurality of modules receives communications on a second frequency within the Industry, Scientific and Medical Band, wherein the first frequency is different from the second frequency.

15. The traffic information system of claim 14 wherein at least a third module of the plurality of modules receives communications on a third frequency within the Industry, Scientific and Medical Band, wherein the third frequency is different from the first and second frequencies.

16. The traffic information system of claim 15 wherein each of the plurality of modules is capable of transmitting on the first frequency, the second frequency, and the third frequency.

17. The traffic information system of claim 1 wherein, upon receiving one of the vehicle information and the outside information, a first module determines whether one of the vehicle information and the outside information comprises an upstream incident signal, in which case the first module determines an upstream notification distance corresponding to the upstream incident signal.

18. The traffic information system of claim 17 wherein the first module transmits the upstream incident signal to a second module that is upstream of the first module in the network of modules.

19. The traffic information system of claim 17 wherein the first module determines a counter based at least in part on the upstream notification distance and transmits the counter to a second module that is upstream of the first module in the network of modules, the counter for indicating to the second module whether to transmit the upstream incident signal to a third module that is upstream of the second module in the network of modules.

20. A traffic information system comprising:
a. a portable consumer component having:
i. a component communication device for receiving outside information and transmitting vehicle information,
ii. an interface connected to the component communication device for receiving input from a user, and
iii. an output connected to the component communication device for displaying at least one of the outside information and the vehicle information in a human readable format.
b. a plurality of modules each being operable to communicate with the consumer component, each of the plurality of modules having:
i. a module communication device for receiving outside information, transmitting the outside information to the component communication device and receiving vehicle information from the component communication device,
ii. a processor connected to the module communication device for processing the outside information and the vehicle information, and
iii. a memory connected to the processor, and
c. a plurality of network stations, which, together with the plurality of modules, form a network, each of the plurality of network stations being in communication with the network, and each of the plurality of modules being in communication with the network, each of the network stations having:
i. a network station communication device for transmitting the outside information to one or more of the modules and receiving the vehicle information from one or more of the modules and the consumer components,
ii. a network station processor connected to the network station communication device, the network station processor for processing the vehicle information and the outside information, and
iii. a network station memory connected to the network station processor.

21. The traffic information system of claim 20 wherein the outside information comprises advertising information.

22. The traffic information system of claim 20 further comprising a server in communication with one or more of the network stations, the server for transmitting the outside information to one or more of the network stations and receiving the vehicle information from one or more of the network stations.

23. The traffic information system of claim 22 further comprising an Internet server for providing a connection between the server and the Internet.

24. The traffic information system of claim 22 wherein the outside information comprises advertising information and the Internet server is also for communicating with one or more advertisers, the advertisers providing the advertising information to the Internet server.

25. A traffic information system for communicating with a driver of a vehicle, the traffic information system comprising:
a. consumer component means associated with the vehicle, the consumer component means comprising:
i. component communication means for receiving outside information and transmitting vehicle information,
ii. interface means connected to the component communication means for receiving input from the driver, and
iii. output means connected to the component communication means for displaying at least one of the outside information and the vehicle information in a human readable format, and
b. a network of modules, wherein each of the modules is in communication with at least one other module, and is operable to communicate with the consumer component means, the modules each having:
i. module communication means for receiving outside information. transmitting the outside information to the component communication means and receiving vehicle information from the component communication means,
ii. processor means connected to the module communication means for processing the outside information and the vehicle information, and
iii. memory means connected to the processor.
